(19) United States
(12) Patent Application Publication
(10) Pub. No.: US 2004/0201357 A1
(43) Pub. Date: Oct. 14, 2004

(54) Driving apparatus, action amount error detection method and information recording medium for action amount error detection

(75) Inventor: Hiroshi Kobayashi, Kawagoe-shi (JP)

Correspondence Address: LADAS & PARRY, Suite #2100, 5670 Wilshire Boulevard, Los Angeles, CA, 90036-5679, US

(73) Assignee: PIONEER CORPORATION

(21) Appl. No.: 10/806,889

(22) Filed: Mar. 22, 2004

(30) Foreign Application Priority Data
Apr. 10, 2003 (JP) P2003-106345

(51) Int. Cl. H02P 1/04

(52) U.S. Cl. 318/471

(57) ABSTRACT

A driving apparatus having driving device and a driven portion to be driven by the driving device, is provided with: an information obtaining device which obtains at least one of temperature information inside or around the apparatus, humidity information inside or around the apparatus, or voltage information inside the apparatus; an action amount monitoring device which monitors an action amount of the driven portion; and an error detection device which refers to a different action amount error detection value according to a value related to the obtained information and detecting an action amount error of the driven portion based on the action amount error detection value.

### BACKGROUND OF THE INVENTION

1. Field of the Invention

The present invention relates to a technical field of a driving apparatus or the like having a driving device and a driven portion to be driven by the driving device, and an electronics device comprising the same.

2. Related Art

As for electronics devices mounted on a vehicle including audio and visual apparatuses such as car audio equipment and a navigation apparatus, comprising a mobile display panel having a display screen are known. (see; U.S. Pat. No. 6,373,213 B1)

For instance, Patent Document 1 discloses the navigation apparatus having a display panel driving apparatus which accommodates a display panel in a storage portion of the apparatus when not used and opens it by pulling it out and rotating it as if raising it when used. Such a display panel driving apparatus performs an error process in the case where the display panel does not act (move) by a predetermined amount in a predetermined time.

An action amount of a drive system of a display panel and so on is influenced by environmental changes such as a temperature change. For instance, at a low temperature, acting speed of the drive system is reduced (action amount decreases) because torque of a motor is reduced and a load of a gear, a torque limiter and so on increases. Inversely, at a high temperature, the acting speed of the drive system increases. In particular, such environmental changes are so conspicuous in a vehicle that the action amount of the drive system of the display panel and so on changes conspicuously in conjunction therewith.

As for an apparatus in the past, a change in the action amount due to such environmental changes is not taken into consideration so much. Therefore, there is an inconvenience, for instance, that an error is mistakenly detected at the low temperature even in the case where there is no abnormality in the drive system of the display panel and so on in reality. There is also an inconvenience that it is difficult to set sensitivity of error detection high in order to avoid such mistaken detection.

Thus, the present invention has been implemented considering resolution of the inconveniences as one of issues, and an object thereof is to provide a driving apparatus, an action amount error detection method and so on capable of detecting the error in accordance with an optimum action amount according to the environmental changes.

### SUMMARY OF THE INVENTION

The above object of the present invention can be achieved by an driving apparatus of the present invention. The driving apparatus having driving device and a driven portion to be driven by the driving device, is provided with: an information obtaining device which obtains at least one of temperature information inside or around the apparatus, humidity information inside or around the apparatus, or voltage information inside the apparatus; an action amount monitoring device which monitors an action amount of the driven portion; and an error detection device which refers to a different action amount error detection value according to a value related to the obtained information and detecting an action amount error of the driven portion based on the action amount error detection value.

According to the present invention, different action amount error detection values (action amount error detection values suited to each temperature) are referred to according to the temperature in or around the apparatus (value related to the temperature information) so that the action amount error of a panel portion is detected. Therefore, it is possible, even if the action amount (acting speed) of the panel portion changes, to perform the error process in accordance with an optimum action amount (acting speed) of the panel portion at each temperature.

Therefore, it is possible to prevent unnecessary action amount error detection (wrong detection) from being performed so as to curb execution of an unnecessary error process such as stopping the drive of the panel portion. Thus, the error process is no longer executed so that complaints and troubles for the user can be resolved. Furthermore, it is possible to extend the temperature range of a drive guarantee of the panel portion. According to such a configuration, it is possible, even if the action amount (acting speed) of the panel portion changes due to the humidity change, to perform the error process in accordance with the optimum action amount (acting speed) of the panel portion at each humidity so that the abovementioned effect can be obtained. According to such a configuration, it is possible, even if the action amount (acting speed) of the panel portion changes due to a change in the power supply voltage, to perform the error process in accordance with the optimum action amount (acting speed) of the panel portion at each voltage so that the abovementioned effect can be obtained.

In one aspect of the present invention can be achieved by the driving apparatus of the present invention. The driving apparatus of the present invention is, wherein the error detection device switches the action amount error detection value to be referred to according to variation in the value related to the obtained information.

According to the present invention, the action amount error detection value is determined according to the temperature. For instance, it is possible to enhance sensitivity of the action amount error detection at a high temperature so as to perform the actual error detection (such as the case where a thing is stuck between a panel portion and a housing) more promptly and perform the error process such as stopping the drive of the panel portion promptly.

In another aspect of the present invention can be achieved by the driving apparatus of the present invention. The driving apparatus of the present invention is, wherein the error detection device refers to the action amount error detection value from an action amount table in which the different action amount error detection value is set correspondingly to each of a plurality of ranges.

According to the present invention, different action amount error detection values (action amount error detection values suited to each temperature) in the action amount table are referred to according to the temperature in or around the apparatus (value related to the temperature information) so that the action amount error of a panel portion is detected. Therefore, it is possible, even if the action amount (acting speed) of the panel portion changes, to perform the error process in accordance with an optimum action amount (acting speed) of the panel portion at each temperature.

Therefore, it is possible to prevent unnecessary action amount error detection (wrong detection) from being performed so as to curb execution of an unnecessary error process such as stopping the drive of the panel portion. Thus, the error process is no longer executed so that complaints and troubles for the user can be resolved. Furthermore, it is possible to extend the temperature range of a drive guarantee of the panel portion.

In further aspect of the present invention can be achieved by the driving apparatus of the present invention. The driving apparatus of the present invention is further provided with an acting position recognition device which recognizes an acting position of the driven portion, wherein the error detection device refers to the different action amount error detection value according to the value related to the obtained information and the recognized acting position, and detects the action amount error of the driven portion based on the action amount error detection value.

According to the present invention, the action amount error detection value is determined according to the temperature. For instance, it is possible to enhance sensitivity of the action amount error detection at a high temperature so as to perform the actual error detection (such as the case where a thing is stuck between a panel portion and a housing) more promptly and perform the error process such as stopping the drive of the panel portion promptly.

In further aspect of the present invention can be achieved by the driving apparatus of the present invention. The driving apparatus of the present invention is, wherein the error detection device switches the action amount error detection value to be referred to according to the recognized acting position.

According to the present invention, it is also constituted to refer to the temperature and different action amount error detection values according to the acting positions of a panel portion so as to detect the action amount error of the panel portion based on them. Therefore, it is possible to perform a convenient handling (process) such as appropriately switching the action amount error detection value according to the temperature change when the panel portion is at the acting position easily influenced by the temperature and not appropriately switching the action amount error detection value even if the temperature changes when the panel portion is at the acting position hardly influenced by the temperature.

The above object of the present invention can be achieved by an action amount error detection process program of the present invention. The action amount error detection process program embodied in a recording medium which can be read by a computer in an a driving apparatus having driving device and a driven portion to be driven by the driving device, the program making the computer function as: an information obtaining device which obtains at least one of temperature information inside or around the apparatus, humidity information inside or around the apparatus, or voltage information inside the apparatus; an action amount monitoring device which monitors an action amount of the driven portion; and an error detection device which refers to a different action amount error detection value according to a value related to the obtained information and detects an action amount error of the driven portion based on the action amount error detection value.

According to the present invention, different action amount error detection values (action amount error detection values suited to each temperature) are referred to according to the temperature in or around the apparatus (value related to the temperature information) so that the action amount error of a panel portion is detected. Therefore, it is possible, even if the action amount (acting speed) of the panel portion changes, to perform the error process in accordance with an optimum action amount (acting speed) of the panel portion at each temperature.

Therefore, it is possible to prevent unnecessary action amount error detection (wrong detection) from being performed so as to curb execution of an unnecessary error process such as stopping the drive of the panel portion. Thus, the error process is no longer executed so that complaints and troubles for the user can be resolved. Furthermore, it is possible to extend the temperature range of a drive guarantee of the panel portion. According to such a configuration, it is possible, even if the action amount (acting speed) of the panel portion changes due to the humidity change, to perform the error process in accordance with the optimum action amount (acting speed) of the panel portion at each humidity so that the abovementioned effect can be obtained. According to such a configuration, it is possible, even if the action amount (acting speed) of the panel portion changes due to a change in the power supply voltage, to perform the error process in accordance with the optimum action amount (acting speed) of the panel portion at each voltage so that the abovementioned effect can be obtained.

The above object of the present invention can be achieved by an information recording medium of the present invention. The information recording medium in which an action amount error detection process program is recorded in a readable way by a recording computer included in a driving apparatus which has a driving device and a driven portion to be driven by the driving device, the action amount error detection process program causing the recording computer to function as: an information obtaining device which obtains at least one of temperature information inside or around the apparatus, humidity information inside or around the apparatus, or voltage information inside the apparatus; an action amount monitoring device which monitors an action amount of the driven portion; and an error detection device which refers to a different action amount error detection value according to a value related to the obtained information and detects an action amount error of the driven portion based on the action amount error detection value.

According to the present invention, it is possible, even if the action amount (acting speed) of the panel portion changes, to perform the error process in accordance with an optimum action amount (acting speed) of the panel portion at each temperature.

### BRIEF DESCRIPTION OF THE DRAWINGS

FIG. 1 is a block diagram showing an overview configuration example of a panel driving apparatus S according to this embodiment;

FIGS. 2A, 2B and 2C are diagrams showing how a panel portion 2 is pulled out of an accommodation portion and becomes usable;

FIG. 3 is a conceptual diagram showing an example of an action amount table stored in a ROM;

FIG. 4 is a flowchart showing a process of a control portion 6 on opening the panel portion 2; and

FIG. 5 is a flowchart showing the process of the control portion 6 on accommodating the panel portion 2.

### DETAILED DESCRIPTION OF THE PREFERRED EMBODIMENTS

Hereafter, a preferred embodiment of the present invention will be described based on attached drawings. A description will be given below as to an embodiment in the case of applying the present invention to a panel driving apparatus provided to a car-mounted navigation apparatus.

The car-mounted navigation apparatus is provided with a GPS (Global Positioning System) receiving portion for receiving an electric wave broadcasted from a GPS satellite and detecting a current position information (latitude and longitude), a sensor portion including a velocity sensor, an acceleration sensor, a gyro sensor and soon, a storage portion for storing various information necessary for a navigation process of map information and so on, and a control portion for performing the navigation process to provide the map information, routing assistance information and so on to a destination to an occupant (user). A detailed description of these components will be omitted because they are not directly related to the present invention.

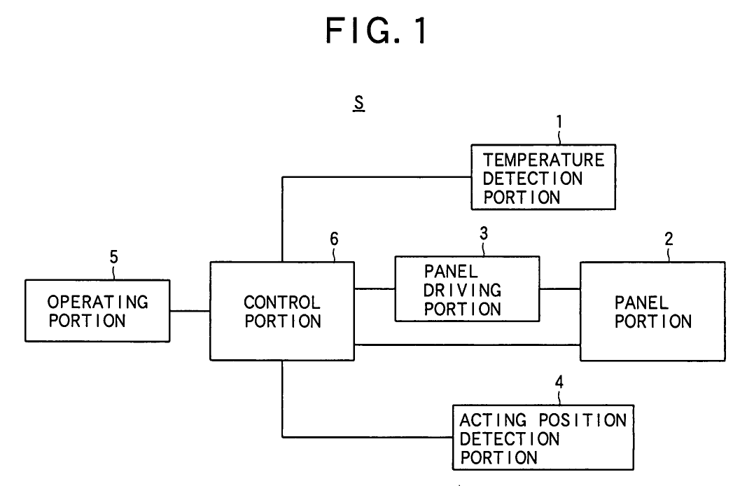

First, a configuration and functions of the panel driving apparatus of this embodiment included in the car-mounted navigation apparatus will be described by referring to FIGS. 1 to 3. FIG. 1 is a block diagram showing an overview configuration example of a panel driving apparatus S according to this embodiment.

As shown in FIG. 1, the panel driving apparatus S is comprised of a temperature detection portion 1, a panel portion (panel member) 2 as a driven portion, a panel driving portion 3 as a driving device, an acting position detection portion 4, an operating portion 5, and a control portion 6 as an information obtaining device, an acting position recognition device, an action amount monitoring device and an error detection device. It is also possible to provide the temperature detection portion 1 and operating portion 5 in the car-mounted navigation apparatus outside the panel driving apparatus S, or outside the car-mounted navigation apparatus so that the panel driving apparatus S can obtain information therefrom.

The temperature detection portion 1 is provided with a thermistor circuit, an AD converter and so on, and detects a temperature inside or around the apparatus. For instance, the thermistor circuit has the configuration wherein a resistance and a thermistor are series-connected, a voltage (fixed voltage) is applied to one end of the resistance, and one end of the thermistor is grounded. As a resistance value of the thermistor changes in conjunction with a temperature change, the voltage of a connection point of the resistance and the thermistor also changes in conjunction with the change. The temperature detection portion 1 converts the voltage of the connection point of the resistance and the thermistor into a digital value with the AD converter, and then provides this voltage value as temperature information to the control portion 6. A temperature detection element other than the thermistor (a semiconductor, for instance) may also be applied as long as it is an element of which resistance value changes in conjunction with the temperature change.

The panel portion 2 is provided with a liquid crystal display (LCD) panel having a display screen, for instance, a touch panel input portion including a touch panel provided on the display screen and soon. The map information, routing assistance information to a destination, and a menu including various selection buttons necessary for the navigation process and so on are displayed, for instance, on the display screen of the liquid crystal display panel. The touch panel has two opposed transparent resistive layers (made of ITO (indium tin oxide) for instance) deposited and formed on a transparent substrate of glass, film or the like. The touch panel input portion detects a coordinate position contacted by a finger or a pen or the like on the touch panel and AD-converts it with the AD converter, and then outputs a signal indicating the coordinate position to the control portion 6. Thus, contact (push) with a selection button and so on displayed on the display screen of the liquid crystal display panel is detected by the control portion 6.

The panel portion 2 is accommodated in an accommodation portion of the car-mounted navigation apparatus body (hereafter, referred to as a “housing”) when not used, and is pulled out when used.

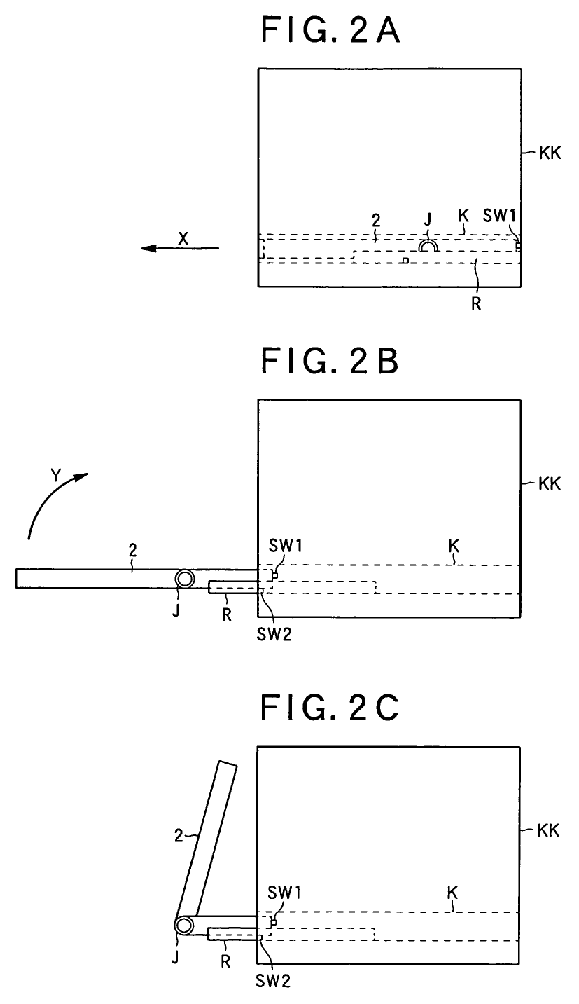

FIGS. 2A, 2B and 2C are diagrams showing how the panel portion 2 is pulled out of the accommodation portion and becomes usable. The panel portion 2 is driven by the panel driving portion 3 as shown in FIGS. 2A, 2B and 2C.

The panel driving portion 3 is provided with a rotary motor and a gear for rotatively driving the panel portion 2 centering on an axis J (refer to FIGS. 2A, 2B and 2C) in the panel portion 2, a rotary motor driver for driving the rotary motor, a slider motor and a gear for moving the panel portion 2 to the right and left (pull-out drive or pull-in drive) in FIGS. 2A, 2B, and 2C together with a pull-out rail R, and a slider motor driver for driving the slider motor. These drivers are controlled by driving signals from the control portion 6 respectively, and drive the rotary motor and the slider motor respectively.

And in the case where the panel portion 2 is used, the panel portion 2 (including the axis J) is pulled out of an accommodation portion K in a housing KK from an accommodation position shown in FIG. 2A in an arrow direction X therein as if sliding on the pull-out rail R so as to be at an intermediate position shown in FIG. 2B. Subsequently, the panel portion 2 is turned in an arrow direction Y centering on the axis J in FIG. 2B and is thereby set up so that it is at a use position shown in FIG. 2C (the position at which the display screen of the liquid crystal display panel is facing the occupant (user) and usable). In the case where the panel portion 2 is accommodated in the accommodation portion K after use, contrary to a series of the above-mentioned actions, the panel portion 2 is first turned from the use position shown in FIG. 2C and is thereby pulled down to the intermediate position (FIG. 2B) capable of dragging the panel portion 2 into the accommodation portion K. Next, the panel portion 2 is accommodated in a pulled-down state in the accommodation portion K in the housing KK by sliding on the pull-out rail R together with the axis J so as to be at the accommodation position shown in FIG. 2A.

In the following description, opening of the panel portion 2 refers to the action in which the panel portion 2 at the accommodation position is pulled out and turned from the intermediate position until the panel portion 2 gets to the use position. Accommodation of the panel portion 2 refers to the action in which the panel portion 2 at the use position is turned and pulled in from the intermediate position until the panel portion 2 gets to the accommodation position.

Next, the acting position detection portion 4 is provided with a pull-in switch SW1 and a pull-out switch SW2 provided to the panel portion 2 and an encoder provided to the axis J of the panel portion 2, for instance, and detects an acting position of the panel portion 2 (each position determined by driving of the panel portion 2) so as to generate an acting position detection signal and output it to the control portion 6. To be more specific, the pull-in switch SW1 performs an on-operation (detects that the panel portion 2 is at the accommodation position) by contacting an inner wall of the housing KK when the panel portion 2 is completely accommodated in the accommodation portion K (the accommodation position shown in FIG. 2A) so as to generate an accommodation position detection signal and output it to the control portion 6. The pull-out switch SW2 performs the on-operation (detects that the panel portion 2 is at the intermediate position) by contacting the inner wall of the housing KK (lower inside of an opening for accommodating the panel portion 2) when the panel portion 2 is completely pulled out of the accommodation portion K (the intermediate position shown in FIG. 2B) so as to generate an intermediate position detection signal and output it to the control portion 6.

The encoder generates a rotation position detection signal corresponding to the voltage value approximately proportional to a rotation angle of the panel portion 2 (detects a rotation position of the panel portion 2) and outputs it to the control portion 6. For instance, the encoder is comprised of circular resistive elements for rotating together with the panel portion 2 and sliding contacts for contacting the resistive elements due to the rotation of the resistive elements and moving thereon. A fixed low voltage (0V for instance) is applied to a terminal of the resistive element in a direction in which the sliding contact moves on accommodating the panel portion 2, and a fixed high voltage (5V for instance) is applied to the terminal of the resistive element in the direction in which the sliding contact moves on opening the panel portion 2. And a potential difference between the terminal of the resistive element having the fixed voltage applied thereto and the sliding contact is outputted as the rotation position detection signal to the control portion 6. To be more specific, the voltage of the rotation position detection signal increases on the opening, and decreases on the accommodation. The control portion 6 recognizes in advance the voltage of the rotation position detection signal when the panel portion 2 reaches the use position (FIG. 2C) as a maximum opening voltage value and the voltage of the rotation position detection signal when the panel portion 2 reaches the intermediate position (FIG. 2B) as a minimum opening voltage value.

Next, the operating portion 5 has operation buttons for receiving instructions from the occupant (user) (a panel opening instruction, a panel accommodation instruction and so on for instance) and generates instruction signals (a panel opening instruction signal, a panel accommodation instruction signal and so on for instance) based on received instructions so as to output them to the control portion 6.

Next, the control portion 6 is provided with a CPU (Central Processing Unit) having a computing function, ROMs (Read-Only Memory) for storing various data, tables and programs (including an action amount error detection process program: this action amount error detection process program may either be downloaded from a server on the Internet or be recorded on a recording medium such as a CD-ROM and provided), RAMs (Random-Access Memory) for work and so on, where the CPU executes the programs to control the components of the panel driving apparatus.

To be more precise, the control portion 6 executes the process described later according to the instruction signal from the operating portion 5 and the acting position detection signal from the acting position detection portion 4, and outputs the driving signal to the panel driving portion 3 so as to control the opening and accommodation of the panel portion 2. In such a process, the control portion 6 monitors the action amount (movement amount) of the panel portion 2 and refers to an action amount error detection value set in an action amount table so as to detect an action amount error of the panel portion 2 based on the action amount error detection value and perform an error process.

Here, the action amount of the panel portion 2 refers to the amount indicating to what degree the panel portion 2 acted (rotation or horizontal movement or the like) in a predetermined time. In other words, the action amount of the panel portion 2 is equivalent to acting speed (moving speed) of the panel portion 2 (the higher the acting speed of the panel portion 2 is, the larger the action amount becomes). The action amount error detection value refers to a threshold for detecting the action amount error of the panel portion 2 (the action amount of the panel portion 2 is too small (that is, the acting speed of the panel portion 2 is too slow), for instance).

According to this embodiment, the action amount error detection value is set by a parameter of time. For instance, the control portion 6 detects the action amount error in the case where the panel portion 2 does not act by a predetermined action amount (for instance, the action amount from the accommodation position to the intermediate position (horizontal movement amount)) within predetermined time (3 seconds) which is the action amount error detection value.

The action amount of the panel portion 2 is monitored by the acting position detection signal or the like from the acting position detection portion 4.

Furthermore, the control portion 6 obtains the temperature information from the temperature detection portion 1, and refers to different action amount error detection values according to values related to such temperature information so as to detect the action amount error of the panel portion 2 based on the action amount error detection values. To be more specific, the control portion 6 switches the action amount error detection value to be referred to according to the detected temperature change.

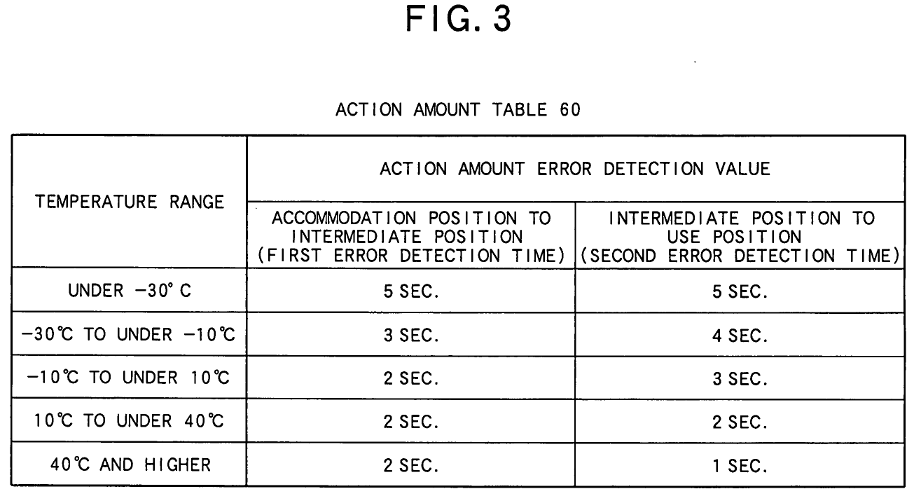

FIG. 3 is a conceptual diagram showing an example of the action amount table stored in the ROM. As shown in FIG. 3, an action amount table 60 has different action amount error detection values set therein correspondingly to each of a plurality of temperature ranges (as for the example in FIG. 3, five divisions of under −30° C., −30° C. to under −10° C., −10° C. to under 10° C., 10° C. to under 40° C., and 40° C. and higher). Furthermore, the action amount table 60 has different action amount error detection values set therein correspondingly to each of the acting positions of the panel portion 2 (as for the example in FIG. 3, two divisions of the accommodation portion to the intermediate position, and the intermediate position to the use position). For instance, the action amount error detection value (error detection time) of the intermediate position to the use position of the panel portion 2 is set to gradually increase as the temperature goes down. This is because, for instance, the action (rotation) of the panel portion 2 in the intermediate position to the use position is apt to be influenced by the temperature and so the acting speed is reduced as the temperature goes down. The action (horizontal movement) of the panel portion 2 in the accommodation portion to the intermediate position is not much influenced by the temperature at a certain temperature or higher (−10° C. or higher) so that the action amount error detection value (error detection time) at the temperature or higher is set at a same value.

In the following description, the action amount error detection value in the accommodation position to the intermediate position is referred to as a first error detection time, and the action amount error detection value in the intermediate position to the use position is referred to as a second error detection time.

As the action amount table 60 is set as above, the control portion 6 refers not only to the temperature information but also to the action amount error detection value which is different according to the acting position of the panel portion 2 so as to detect the action amount error of the panel portion 2 based on it. To be more specific, the control portion 6 switches the action amount error detection value to be referred to according to the acting position of the panel portion 2.

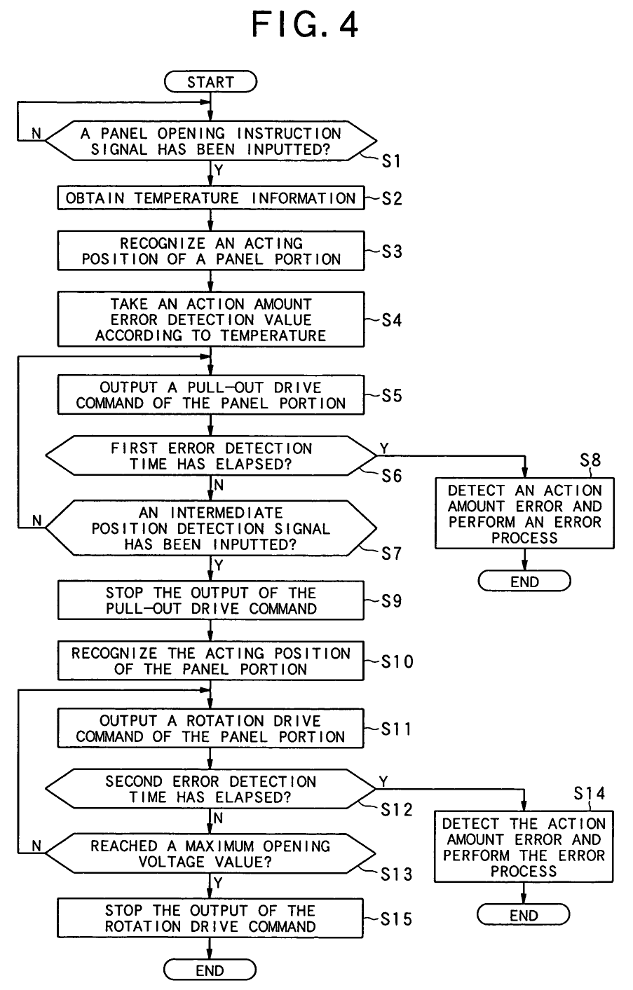

Next, a description will be given as to operation of the panel driving apparatus S on opening the panel portion 2 by referring to FIG. 4 and so on.

FIG. 4 is a flowchart showing the process of the control portion 6 on opening the panel portion 2.

First, if the occupant (user) pushes down a panel opening instruction button in the operating portion 5 when the panel portion 2 is at the accommodation position (FIG. 2A), the operating portion 5 generates the panel opening instruction signal and outputs it to the control portion 6.

In FIG. 4, in the case where the control portion 6 recognizes an input of the panel opening instruction signal from the operating portion 5 (step S1: YES), the control portion 6 obtains the temperature information from the temperature detection portion 1 (step S2). Subsequently, the control portion 6 receives the acting position detection signal from the acting position detection portion 4 (in this case, the accommodation position detection signal from the pull-in switch SW1) and recognizes the acting position (accommodation position in this case) of the panel portion 2 based on the acting position detection signal (step S3).

Next, the control portion 6 refers to the action amount table 60 stored in the ROM. The control portion 6 identifies the temperature range including the value related to the temperature information (for instance, in the case of the value indicating the temperature of 3° C. (represented by the voltage value in reality), the temperature ranges of −10° C. to under 10° C. including the temperature), and takes a first error detection time (2 seconds for instance) and a second error detection time (3 seconds for instance) in the temperature range (takes the action amount error detection values according to the temperature) and sets them (step S4).

Next, the control portion 6 outputs a pull-out drive command (driving signal to the slider motor) of the panel portion 2 to the panel driving portion 3 (step S5), and starts timekeeping with an unshown timer in the CPU. Thus, the slider motor is driven by the slider motor driver, and a pull-out drive of the panel portion 2 is started.

And the control portion 6 determines whether or not the first error detection time (2 seconds for instance) set as above has elapsed (step S6). In the case where it has not elapsed, it determines whether or not the intermediate position detection signal has been inputted from the acting position detection portion 4 (that is, the panel portion 2 has been pulled out to the intermediate position (FIG. 2B) and the pull-out switch SW2 has on-operated) (step S7). To be more specific, the control portion 6 monitors the action amount of the panel portion 2, and outputs the pull-out drive command to the panel driving portion 3 until the intermediate position detection signal is inputted from the acting position detection portion 4 within the first error detection time.

And in the case where the first error detection time has elapsed (step S6: YES), the control portion 6 detects the action amount error of the panel portion 2 and performs the error process (step S8) so as to finish the process. To be more specific, the action amount error is detected because the panel portion 2 did not act by the predetermined action amount (action amount from the accommodation position to the intermediate position) within the first error detection time.

In the error process, the control portion 6 outputs to the panel driving portion 3 a command for stopping the pull-out drive of the panel portion 2 or a command for performing the pull-out drive in a direction opposite to the pullout of the panel portion 2 (accommodation position direction) for instance. In the error process, the control portion 6 also causes an unshown display portion and a speaker of the car-mounted navigation apparatus to produce a display and present an audio output to the effect that it is the action amount error of the panel portion 2.

In the case where the intermediate position detection signal is inputted from the acting position detection portion 4 within the first error detection time (step S7: YES), the control portion 6 stops the output of the pull-out drive command (step S9), clears the timer (stops the timekeeping) and recognizes the acting position (intermediate position in this case) of the panel portion 2 (step S10).

Next, the control portion 6 outputs a rotation drive command (driving signal to the rotary motor) of the panel portion 2 to the panel driving portion 3 (step S11), and starts the timekeeping with the unshown timer in the CPU. Thus, the rotary motor is driven by the rotary motor driver, and the rotation drive (clockwise) of the panel portion 2 is started.

And the control portion 6 starts receiving the rotation position detection signal from the acting position detection portion 4 and determines whether or not the second error detection time (3 seconds for instance) set as above has elapsed (step S12). In the case where it has not elapsed, it determines whether or not the voltage of the rotation position detection signal has reached a preset maximum opening voltage value (that is, the panel portion 2 has turned to the use position (FIG. 2C)) (step S13). To be more specific, the control portion 6 monitors the action amount of the panel portion 2, and outputs the rotation drive command to the panel driving portion 3 until reaching the maximum opening voltage value within the second error detection time.

And in the case where the second error detection time has elapsed (step S12: YES), the control portion 6 detects the action amount error of the panel portion 2 and performs the error process (step S14) so as to finish the process. To be more specific, the action amount error is detected because the panel portion 2 did not act by the predetermined amount (action amount from the intermediate position to the use position) within the second error detection time.

In the error process, the control portion 6 outputs to the panel driving portion 3 a command for stopping the rotation drive of the panel portion 2 or a command for rotatively driving the panel portion 2 in a reverse direction (counterclockwise) for instance. In the error process, the control portion 6 also causes the unshown display portion and the speaker of the car-mounted navigation apparatus to produce a display and present an audio output to the effect that it is the action amount error of the panel portion 2.

In the case where the voltage of the rotation position detection signal has reached the maximum opening voltage value within the second error detection time (step S13: YES), the control portion 6 stops the output of the rotation drive command (step S15) and clears the timer (stops the timekeeping) so as to finish the process.

The process is constituted to obtain the temperature information before opening the panel portion 2 and use the action amount error detection value according to the temperature information until finishing the opening (not changed during the action) so as to detect the action amount error. Apart from this, it may also be constituted to obtain the temperature information during the opening of the panel portion 2 and read the action amount error detection value according to the temperature information as appropriate so as to detect the action amount error based on the action amount error detection value.

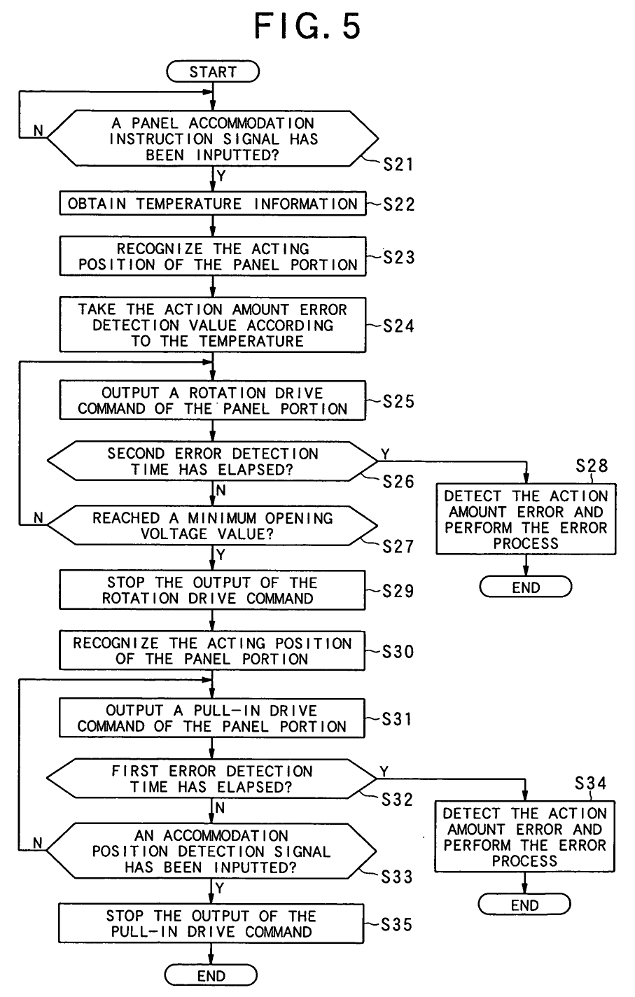

A description will be given by referring to FIG. 5 and so on as to the action of the panel driving apparatus S on accommodating the panel portion 2.

FIG. 5 is a flowchart showing a process of the control portion 6 on accommodating the panel portion 2.

First, if the occupant (user) pushes down a panel accommodation instruction button in the operating portion 5 when a panel portion 2 is at the use position (FIG. 2C), the operating portion 5 generates the panel accommodation instruction signal and outputs it to the control portion 6.

In FIG. 5, in the case where the control portion 6 recognizes the input of the panel accommodation instruction signal from the operating portion 5 (step S21: YES), the control portion 6 obtains the temperature information from the temperature detection portion 1 (step S22). Subsequently, the control portion 6 receives the acting position detection signal from the acting position detection portion 4 (in this case, the rotation position detection signal from the acting position detection portion 4) and recognizes the acting position (use position in this case) of the panel portion 2 based on the acting position signal (based on the fact that the voltage of the rotation position detection signal is the maximum opening voltage value) (step S23).

Next, the control portion 6 refers to the action amount table 60 stored in the ROM. The control portion 6 identifies a temperature range including the value related to the temperature information (for instance, in the case of the value indicating the temperature of 15° C., the temperature ranges of 10° C. to under 40° C. including the temperature), and takes the first error detection time (2 seconds for instance) and the second error detection time (2 seconds for instance) in the temperature range (takes the action amount error detection values according to the temperature) and sets them (step S24).

To be more specific, in the case where the temperature rises (it rises from 3° C. to 15° C.) from the opening of the panel portion 2, the control portion 6 switches the action amount error detection value (second error detection time) between the intermediate position and the use position to be set (3 seconds to 2 seconds). The control portion 6 does not switch the action amount error detection value (first error detection time) between the accommodation position and the intermediate position to be set.

Next, the control portion 6 outputs a rotation drive command (driving signal to the rotary motor) of the panel portion 2 to the panel driving portion 3 (step S25), and starts the timekeeping with the unshown timer in the CPU. Thus, the rotary motor is driven by the rotary motor driver, and the rotation drive (reverse rotation to the opening) of the panel portion 2 is started.

And the control portion 6 determines whether or not the second error detection time (2 seconds for instance) set as above has elapsed (step S26). In the case where it has not elapsed, it determines whether or not the voltage of the rotation position detection signal has reached a preset minimum opening voltage value (that is, the panel portion 2 has turned to the intermediate position (FIG. 2B)) (step S27).

And in the case where the second error detection time has elapsed (step S26: YES), the control portion 6 detects the action amount error of the panel portion 2 and performs the error process (step S28) so as to finish the process.

In the error process, the control portion 6 outputs to the panel driving portion 3 a command for stopping the rotation drive of the panel portion 2 or a command for rotatively driving the panel portion 2 in a reverse direction (clockwise) for instance. In the error process, the control portion 6 also causes the unshown display portion and the speaker of the car-mounted navigation apparatus to produce the display and present the audio output to the effect that it is the action amount error of the panel portion 2.

In the case where the voltage of the rotation position detection signal has reached the minimum opening voltage value within the second error detection time (step S27: YES), the control portion 6 stops the output of the rotation drive command (step S29), clears the timer (stops the timekeeping) and recognizes the acting position (intermediate position in this case) of the panel portion 2 (step S30).

Next, the control portion 6 outputs a pull-in drive command (driving signal to the slider motor) of the panel portion 2 to the panel driving portion 3 (step S31), and starts the timekeeping with the unshown timer in the CPU. Thus, the slider motor is driven by the slider motor driver, and the pull-in drive of the panel portion 2 is started.

And the control portion 6 determines whether or not the first error detection time (2 seconds for instance) set as above has elapsed (step S32). In the case where it has not elapsed, the control portion 6 determines whether or not the accommodation position detection signal has been inputted from the acting position detection portion 4 (that is, the panel portion 2 has been pulled in to the accommodation position (FIG. 2A) and the pull-in switch SW1 has on-operated) (step S33).

And in the case where the first error detection time has elapsed (step S32: YES), the control portion 6 detects the action amount error of the panel portion 2 and performs the error process (step S34) so as to finish the process.

In the error process, the control portion 6 outputs to the panel driving portion 3 a command for stopping the pull-in drive of the panel portion 2 or a command for performing the pull-out drive in a direction opposite to the pull-in of the panel portion 2 (intermediate position direction) for instance. In the error process, the control portion 6 also causes the unshown display portion and the speaker of the car-mounted navigation apparatus to produce the display and present the audio output to the effect that it is the action amount error of the panel portion 2.

In the case where the accommodation position detection signal has been inputted from the acting position detection portion 4 within the first error detection time (step S33: YES), the control portion 6 stops the output of the pull-in drive command (step S35) and clears the timer (stops the timekeeping) so as to finish the process.

According to the process, the control portion 6 obtains the temperature information before accommodating the panel portion 2 and uses the action amount error detection value according to the temperature information until finishing the accommodation (not changed during the action) so as to detect the action amount error. Apart from this, it may also be constituted to obtain the temperature information during the accommodation of the panel portion 2 and read the action amount error detection value according to the temperature information as appropriate so as to detect the action amount error based on the action amount error detection value.

As described above, according to the embodiment, different action amount error detection values (action amount error detection values suited to each temperature) as shown in the action amount table 60 are referred to according to the temperature in or around the apparatus (value related to the temperature information) so that the action amount error of the panel portion 2 is detected. Therefore, it is possible, even if the action amount (acting speed) of the panel portion 2 changes, to perform the error process in accordance with an optimum action amount (acting speed) of the panel portion 2 at each temperature.

Therefore, it is possible to prevent unnecessary action amount error detection (wrong detection) from being performed so as to curb execution of an unnecessary error process such as stopping the drive of the panel portion 2. Thus, the error process is no longer executed so that complaints and troubles for the user can be resolved. Furthermore, it is possible to extend the temperature range of a drive guarantee of the panel portion 2.

The action amount error detection value is determined according to the temperature. For instance, it is possible to enhance sensitivity of the action amount error detection at a high temperature so as to perform the actual error detection (such as the case where a thing is stuck between the panel portion 2 and the housing) more promptly and perform the error process such as stopping the drive of the panel portion 2 promptly.

It is also constituted to refer to the temperature and different action amount error detection values according to the acting positions of the panel portion 2 so as to detect the action amount error of the panel portion 2 based on them. Therefore, it is possible to perform a convenient handling (process) such as appropriately switching the action amount error detection value according to the temperature change when the panel portion 2 is at the acting position easily influenced by the temperature and not appropriately switching the action amount error detection value even if the temperature changes when the panel portion 2 is at the acting position hardly influenced by the temperature.

The embodiment described the case where the action amount error detection values of the acting position (the first error detection time and the second error detection time) are the same on the accommodation and on the opening. It is also possible, however, to render them different between the accommodation and the opening. For instance, it is also possible, by considering a difference in a load between rising of the panel portion 2 from the intermediate position to the use position and lowering thereof from the use position to the intermediate position, to set the action amount error detection value between the intermediate position and the use position on the opening larger than that on the accommodation.

The embodiment also described an example of the case where the acting position of the panel portion 2 is divided into two sections of the accommodation position to the intermediate position and the intermediate position to the use position. However, it is not limited thereto but the acting position of the panel portion 2 may be divided into more sections. For instance, it is thinkable to further divide the section of the intermediate position to the use position into the section from a start of the movement (requiring a higher torque) to a predetermined angle (detected by the voltage of the rotation position detection signal from the encoder of the acting position detection portion 4) and the section from the predetermined angle to the use position so as to set the action amount error detection value of the start of movement to the predetermined angle larger than that of the predetermined angle to the use position.

The embodiment is an example wherein the action amount error is detected in the case where the acting speed of the panel portion 2 is too low. It is also possible, as another example, to constitute it to detect the action amount error in the case where the acting speed of the panel portion 2 is too high.

According to the embodiment, the action amount of the panel portion 2 such as that of the accommodation position to the intermediate position is monitored based on the acting position detection signals or the like from the pull-in switch SW1 and pull-out switch SW2. However, it is not limited thereto, but it is also possible, for instance, to have the number of pulses from the slider motor or the like in the panel driving portion 3 counted and compared to a reference count number per predetermined time by the control portion 6.

According to the embodiment, the control portion 6 refers to different action amount error detection values according to the values related to the temperature information so as to detect the action amount error of the panel portion 2 based on the action amount error detection values. However, it is not limited thereto, but it is also possible, for instance, to refer to different action amount error detection values according to the values related to humidity information in or around the apparatus so as to detect the action amount error of the panel portion 2 based on the action amount error detection values. In the case of this configuration, for instance, a humidity detector such as a hygrometer or the like is provided in the apparatus, and furthermore, different action amount error detection values according to a plurality of humidity ranges are set in the action amount table 60. And the control portion 6 obtains the humidity information detected by the humidity detector, and refers to the different action amount error detection values in the action amount table 60 according to the value related to the humidity information (such as the value indicating the humidity of 90 percent) so as to detect the action amount error of the panel portion 2 based on the action amount error detection values. In this case, the processes in FIGS. 4 and 5 are applicable. According to such a configuration, it is possible, even if the action amount (acting speed) of the panel portion 2 changes due to the humidity change, to perform the error process in accordance with the optimum action amount (acting speed) of the panel portion 2 at each humidity so that the same effect as the embodiment can be obtained.

Furthermore, it may be constituted, for instance, so that the control portion 6 refers to different action amount error detection values according to the values related to voltage information in the apparatus so as to detect the action amount error of the panel portion 2 based on the action amount error detection values. In the case of this configuration, for instance, different action amount error detection values according to a plurality of voltage ranges are set in the action amount table 60. And the control portion 6 obtains the voltage information on a power supply voltage and so on, and refers to the different action amount error detection values in the action amount table 60 according to the value related to the voltage information (such as the value indicating the voltage of 4V) so as to detect the action amount error of the panel portion 2 based on the action amount error detection values. In this case, the processes in FIGS. 4 and 5 are also applicable. According to such a configuration, it is possible, even if the action amount (acting speed) of the panel portion 2 changes due to a change in the power supply voltage, to perform the error process in accordance with the optimum action amount (acting speed) of the panel portion 2 at each voltage so that the same effect as the embodiment can be obtained.

It may also be constituted, for instance, so that the action amount error detection values according to combinations of the temperature, humidity and voltage information are set, and the control portion 6 detects the action amount error of the panel portion 2 based on the action amount error detection values.

The embodiment described the case of applying the present invention to the panel driving apparatus for driving the panel portion. However, it is not limited thereto, but it is also possible, for instance, to apply the present invention to the driving apparatus for driving a disk carrying mechanism (a mechanism for carrying and ejecting a disk).

The embodiment described the case of applying the present invention to the driving apparatus included in the car-mounted navigation apparatus. However, it is not limited thereto, but it is also possible, for instance, to apply the present invention to various driving apparatuses included in electronics devices such as a car-mounted AV (Audio Visual) apparatus, the car-mounted navigation apparatus, a car-mounted AV/navigation apparatus and a household AV apparatus.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-106345 filed on Apr. 10, 2003 including the specification, claims, drawings and summary is incorporated herein by reference in its entirety.

What is claimed is:

1. A driving apparatus having driving device and a driven portion to be driven by the driving device, comprising:
an information obtaining device which obtains at least one of temperature information inside or around the apparatus, humidity information inside or around the apparatus, or voltage information inside the apparatus;
an action amount monitoring-device which monitors an action amount of the driven portion; and
an error detection device which refers to a different action amount error detection value according to a value related to the obtained information and detecting an action amount error of the driven portion based on the action amount error detection value.

2. The driving apparatus according to claim 1, wherein the error detection device switches the action amount error detection value to be referred to according to variation in the value related to the obtained information.

3. The driving apparatus according to claim 1, wherein the error detection device refers to the action amount error detection value from an action amount table in which the different action amount error detection value is set correspondingly to each of a plurality of ranges.

4. The driving apparatus according to claim 1, further comprising
an acting position recognition device which recognizes an acting position of the driven portion,
wherein the error detection device refers to the different action amount error detection value according to the value related to the obtained information and the recognized acting position, and detects the action amount error of the driven portion based on the action amount error detection value.

5. The driving apparatus according to claim 4, wherein the error detection device switches the action amount error detection value to be referred to according to the recognized acting position.

6. The driving apparatus according to claim 1, wherein the driven portion is a panel member.

7. An action amount error detection method for a driving apparatus having a driving device and a driven portion to be driven by the driving device, the action amount error detection method comprising:
an information obtaining process of obtaining at least one of temperature information inside or around the apparatus, humidity information inside or around the apparatus, or voltage information inside the apparatus;
an action amount monitoring process of monitoring an action amount of the driven portion; and
an error detecting process of referring process of referring to a different action amount error detection value according to a value related to the obtained information and detecting an action amount error of the driven portion based on the action amount error detection value.

8. An action amount error detection process program embodied in a recording medium which can be read by a computer in an a driving apparatus having driving device and a driven portion to be driven by the driving device, the program making the computer function as:
an information obtaining device which obtains at least one of temperature information inside or around the apparatus, humidity information inside or around the apparatus, or voltage information inside the apparatus;
an action amount monitoring device which monitors an action amount of the driven portion; and
an error detection device which refers to a different action amount error detection value according to a value related to the obtained information and detects an action amount error of the driven portion based on the action amount error detection value.

9. An information recording medium in which an action amount error detection process program is recorded in a readable way by a recording computer included in a driving apparatus which has a driving device and a driven portion to be driven by the driving device, the action amount error detection process program causing the recording computer to function as:
an information obtaining device which obtains at least one of temperature information inside or around the apparatus, humidity information inside or around the apparatus, or voltage information inside the apparatus;
an action amount monitoring device which monitors an action amount of the driven portion; and
an error detection device which refers to a different action amount error detection value according to a value related to the obtained information and detects an action amount error of the driven portion based on the action amount error detection value.
